(19) United States
(12) Patent Application Publication
(10) Pub. No.: US 2013/0195162 A1
(43) Pub. Date: Aug. 1, 2013

(54) SYNCHRONIZATION PROCESSING APPARATUS, SYNCHRONIZATION PROCESSING METHOD AND PROGRAM

(71) Applicant: Sony Corporation, Tokyo (JP)

(72) Inventor: Osamu MATSUNAGA, Kanagawa (JP)

(73) Assignee: Sony Corporation, Tokyo (JP)

(21) Appl. No.: 13/747,655

(22) Filed: Jan. 23, 2013

(30) Foreign Application Priority Data
Jan. 30, 2012 (JP) 2012-016549

(51) Int. Cl. H04L 7/00

(52) U.S. Cl. CPC H04L 7/0054
USPC 375/226

(57) ABSTRACT

A synchronization processing apparatus includes: a jitter amount calculating section that calculates a jitter amount on the basis of a synchronization packet including time information; and a frequency synchronization determining section that calculates an accumulation value of the jitter amounts, and determines whether frequency synchronization is present from the accumulation value.

### FIELD

The present disclosure relates to a synchronization processing apparatus, a synchronization processing method and a program, and more particularly, to a synchronization processing apparatus, a synchronization processing method and program that are capable of performing frequency synchronization determination with high accuracy.

### BACKGROUND

A receiving apparatus has been known that takes time synchronization with a transmitter using a synchronization packet, including time information on the transmission side, transmitted from the transmitter (see JP-A-2004-304809 and JP-A-2010-232845).

FIG. 1 illustrates a configuration example of a receiving apparatus that takes time synchronization with a transmitter in the related art. The receiving apparatus in FIG. 1 corresponds to a configuration of parts relating to a synchronization process within the entire configuration, which can be called a configuration of a synchronization processing device.

The receiving apparatus in FIG. 1 includes an NIC (Network Interface Card) 1, a synchronization packet processing section 2, a frequency error detecting section 3, a clock generating section 4, a counter 5, a timepiece section 6, a synchronization signal generating section 7, and a frequency synchronization determining section 8.

The NIC 1 is connected to a LAN (Local Area Network) that is a non-synchronization network, receives a packet to the receiving apparatus, and outputs the packet to the next stage. In a case where the NIC 1 receives a synchronization packet from a transmitter, the NIC 1 outputs the received synchronization packet to the synchronization packet processing section 2. The synchronization packet includes transmission time information about the time (transmission time) when the transmitter outputs the synchronization packet.

The synchronization packet processing section 2 includes a synchronization packet receiving section 11, a reception time recording section 12, a transmission time recording section 13, and a jitter amount calculating section 14.

The synchronization packet receiving section 11 acquires (receives) the synchronization packet supplied from the NIC 1, and outputs the packet to the reception time recording section 12 and the transmission time recording section 13.

The reception time recording section 12 records a counted value of the counter 5 at the time point when the synchronization packet is received in the synchronization packet receiving section 11, as a reception time. The transmission time recording section 13 extracts and records a transmission time included in the synchronization packet supplied from the synchronization packet receiving section 11. The reception time recording section 12 records (stores) the reception time when the reception time recording section 12 receives two synchronization packets that are immediately next to each other, and the transmission time recording section 13 records (stores) the transmission time of two synchronization packets that are immediately next to each other.

The jitter amount calculating section 14 calculates a jitter amount on the basis of the reception time and the transmission time of the adjacent two synchronization packets, recorded in the reception time recording section 12 and the transmission time recording section 13. That is, the jitter amount calculating section 14 calculates, as the jitter amount, the difference between a first difference between the reception times of the adjacent two synchronization packets and a second difference between the transmission times of the adjacent two synchronization packets.

Specifically, when a reception time and a transmission time relating to a specific synchronization packet are respectively t(a) and s(a) and a reception time and a transmission time me relating to the next specific synchronization packet are respectively t(b) and s(b), the jitter amount calculating section 14 calculates the jitter amount according to the following Formula (1).

The jitter amount=(t(b)−t(a))−(s(b)−s(a)) (1)

In Formula (1) “a” and “b” in the brackets represent sample numbers of the synchronization packet. Here, the calculated jitter amount corresponds to a clock frequency error on the transmission side and the reception side under a circumstance where the influence of variation in the delay time of the synchronization packet on the network is not present. Further, under a circumstance where the influence of variation in the delay time of the synchronization packet on the network is present, the jitter amount corresponds to a value obtained by combining the clock frequency error on the transmission side and the reception side and the influence of variation in the delay time.

The frequency error detecting section 3 includes a filter section 21, an accumulating section 22, a quantizing section 23 and a DAC and LPF section 24.

The jitter amount calculated by the jitter amount calculating section 14 is supplied to the filter section 21. The filter section 21 performs a filtering process, for example, using a smoothing filter that removes noise of the supplied jitter amount. The filter section 21 outputs the jitter amount after noise removal to the accumulating section 22.

The accumulating section 22 accumulates the output of the filter section 21, and outputs the accumulation result to the quantizing section 23. The accumulating section 22 has a function of maintaining a control voltage at a time point of jitter=0.

The quantizing section 23 quantizes the output of the accumulating section 22. The DAC and LPF section 24 D/A-converts a quantized value that is the quantization result of the quantization section 23, and performs a low pass filtering process. The output of the DAC and LPF section 24 is a VCO control voltage (signal) for performing a control for correcting the frequency error.

The clock generating section 4 generates a clock CLK of a predetermined frequency (clock frequency) on the basis of the VCO control voltage from the frequency error detecting section 3, and outputs the result to the counter 5, the timepiece section 6, the synchronization signal generating section 7 and the like. The clock generating section 4 is configured by a voltage variable crystal oscillator such as a VCXO.

The counter 5 counts a clock value on the basis of the clock CLK generated by the clock generating section 4. The counted value of the counter 5 is supplied to the reception time recording section 12 of the synchronization packet processing section 2.

The timepiece section 6 counts the clock value on the basis of the clock CLK generated by the clock generating section 4. The counted value of the timepiece section 6 is rewritten at the transmission time supplied from the transmission time recording section 13 after the frequency synchronization, and is supplied to the synchronization signal generating section 7 as time information.

The synchronization signal generating section 7 generates a synchronization signal on the basis of the clock CLK supplied from the clock generating section 4, and supplies the result to the respective sections of the receiving apparatus. The time information from the timepiece section 6 is used for setting the synchronization signals on the reception side and the transmission side to the same phase.

The frequency synchronization determining section 8 determines whether the frequency synchronization is established on the basis of the VCO control voltage output from the frequency error detecting section 3. In a case where it is determined that the frequency synchronization is established, the frequency synchronization determining section 8 allows the timepiece section 6 to rewrite the counted value based on the transmission time of the synchronization packet supplied from the transmission time recording section 13.

A synchronization process that use the receiving apparatus in FIG. 1 will be briefly described.

First, in the synchronization packet processing section 2, the jitter amount is calculated by Formula (1). Further, in the frequency error detecting section 3, noise of the calculated jitter amount is removed, and then, the VCO control voltage for correcting the frequency error is generated and the result is supplied to the clock generating section 4. In the clock generating section 4, the clock CLK is generated on the basis of the VCO control voltage, and thus, the frequency error of the clock frequency is corrected. The clock CLK of the corrected clock frequency is supplied to the counter and becomes a reference of the counted value when the reception time is recorded by the reception time recording section 12. Accordingly, a frequency lock loop circuit is configured by the reception time recording section 12, the jitter amount calculating section 14, the frequency error detecting section 3, the clock generating section 4, and the counter 5.

The frequency synchronization determining section 8 determines whether the frequency synchronization is established. As the above-mentioned frequency lock loop control is executed for a predetermined time, in a case where it is determined that the frequency synchronization is established, the frequency synchronization determining section 8 allows the timepiece section 6 to rewrite the counted value based on the transmission time of the synchronization packet supplied from the transmission time recording section 12. In a case where the rewriting allowance is output, the timepiece section 6 starts rewriting of the counted value, and outputs the counted value after rewriting to the synchronization signal generating section 7.

### SUMMARY

In the above-described receiving apparatus in the related art, whether the frequency synchronization is established is determined by whether the VCO control voltage for controlling the clock frequency is settled into a value in a specific range. However, since variation in the VCO control voltage includes the variation in the arrival delay time of the synchronization packet on the network, it is difficult to perform determination with high accuracy.

Accordingly, it is desirable to provide a technique that is capable of performing determination of frequency synchronization with high accuracy.

An embodiment of the present disclosure is directed to a synchronization processing apparatus including: a jitter amount calculating section that calculates a jitter amount on the basis of a synchronization packet including time information; and a frequency synchronization determining section that calculates an accumulation value of the jitter amounts, and determines whether frequency synchronization is present from the accumulation value.

Another embodiment of the present disclosure is directed to a synchronization processing method including: calculating a jitter amount on the basis of a synchronization packet including time information; calculating an accumulation value of the calculated jitter amounts; and determining whether frequency synchronization is present from the calculated accumulation value of the jitter amounts.

Still another embodiment of the present disclosure is directed to a program that causes a computer to function as: a jitter amount calculating section that calculates a jitter amount on the basis of a synchronization packet including time information; and a frequency synchronization determining section that calculates an accumulation value of the jitter amounts calculated in the jitter amount calculating section, and determines whether frequency synchronization is present from the accumulation value of the calculated jitter amount.

According to the above embodiments of the present disclosure, the jitter amount is calculated on the basis of the synchronization packet including the time information, the accumulation value of the calculated jitter amounts is calculated, and whether the frequency synchronization is present is determined from the calculated accumulation value of the jitter amounts.

The synchronization processing apparatus may be an independent, apparatus, or may be an internal block that forms a single apparatus.

According to the above embodiments of the present disclosure, it is possible to perform determination of the frequency synchronization with high accuracy.

### BRIEF DESCRIPTION OF THE DRAWINGS

FIG. 1 is a block diagram illustrating a configuration of a receiving apparatus in the related art;

FIG. 2 is a block diagram illustrating a configuration example of a first embodiment of a receiving apparatus to which the present disclosure is applied;

FIG. 3 is a diagram illustrating the relationship between a jitter accumulation value and an arrival delay time;

FIG. 4 is a diagram illustrating the relationship between a jitter accumulation value and an arrival delay time;

FIG. 5 is a diagram illustrating an operation example of a frequency synchronization control according to the first embodiment;

FIG. 6 is a flowchart illustrating a frequency synchronization control process according to the first embodiment;

FIG. 7 is a flowchart illustrating a frequency synchronization determination process according to the first embodiment;

FIG. 8 is a block diagram illustrating a synchronization packet processing section in a case where it matches with IEEE1588 PTP;

FIG. 9 is a block diagram illustrating a configuration example of a second embodiment of a receiving apparatus to which the present disclosure is applied;

FIG. 10 is a block diagram illustrating a configuration example of a third embodiment of a receiving apparatus to which the present disclosure is applied;

FIG. 11 is a block diagram illustrating a configuration example of a fourth embodiment of a receiving apparatus to which the present disclosure is applied;

FIG. 12 is a diagram illustrating an example of a VCO control voltage according to the fourth embodiment;

FIG. 13 is a flowchart illustrating a frequency synchronization control process according to the fourth embodiment; and

FIG. 14 is a block diagram illustrating a configuration example of an embodiment of a computer to which the present disclosure is applied,

### DETAILED DESCRIPTION

Hereinafter, modes for carrying out the present disclosure (hereinafter referred to as embodiments) will be described. Description thereof is performed in the following order:

1. First embodiment of receiving apparatus

2. Second embodiment of receiving apparatus

3. Third embodiment of receiving apparatus

4. Fourth embodiment of receiving apparatus

### 1. First Embodiment

### [Block Diagram Illustrating Configuration of Receiving Apparatus]

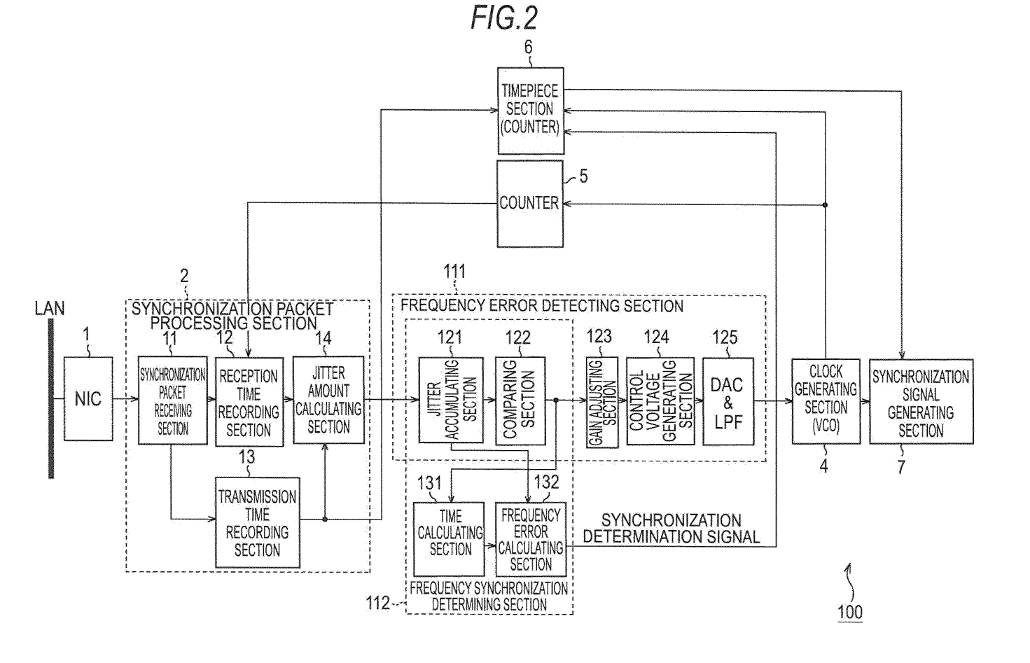

FIG. 2 is a block diagram illustrating a first embodiment of a receiving apparatus.

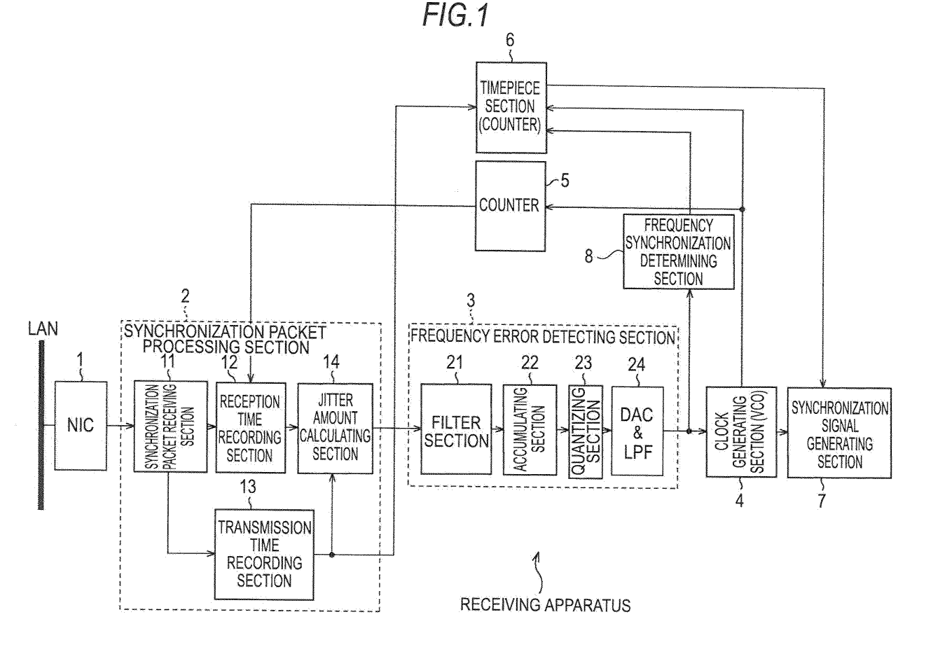

A receiving apparatus 100 in FIG. 2 shows a configuration of a part relating to a synchronization process within the entire configuration, in a similar way to FIG. 1. In FIG. 2, the same reference numerals are given to components corresponding to those in FIG. 1, and repetitive description thereof will be appropriately omitted.

The receiving apparatus 100 in FIG. 2 includes an NIC 1, a synchronization packet processing section 2, a frequency error detecting section 111, a frequency synchronization determining section 112, a clock generating section 4, a counter 5, a timepiece section 6, and a synchronization signal generating section 7.

That is, the receiving apparatus 100 in FIG. 2 is different from the receiving apparatus in FIG. 1 in that the frequency error detecting section 111 is installed instead of the frequency error detecting section 3 of the receiving apparatus in FIG. 1 and the frequency synchronization determining section 112 is installed instead of the frequency synchronization determining section 8 thereof.

The frequency error detecting section 111 includes a jitter accumulating section 121, a comparing section 122, a gain adjusting section 123, a control voltage generating section 124, and a DAC and LPF 125.

The frequency synchronization determining section 112 includes the jitter accumulating section 121, the comparing section 122, a time calculating section 131, and a frequency error calculating section 132. Accordingly, the jitter accumulating section 121 and the comparing section 122 are commonly used in the frequency error detecting section 111 and the frequency synchronization determining section 112.

The jitter accumulating section 121 accumulates jitter amounts that are sequentially supplied from a jitter amount calculating section 14, and outputs a jitter accumulation value that is the accumulation result to the comparing section 122.

The comparing section 122 compares the jitter accumulation value from the jitter accumulating section 121 with an upper limit threshold value DH (hereinafter referred to as an upper limit value DH) and a lower limit threshold value DL (hereinafter, referred to as a lower limit value DL), to determine whether the jitter accumulation value reaches any one of the upper limit value DH or the lower limit value DL. Here, the expression that the jitter accumulation value reaches any one of the upper limit value DH or the lower limit value DL means that the jitter accumulation value is equal to or is beyond the upper limit value DH or the lower limit value DL. The upper limit value DH and the lower limit value DL are set in the comparing section 122 in advance.

In a case where the jitter accumulation value reaches the upper limit value DH, the comparing section 122 outputs a control value corresponding to the upper limit value DH to the gain adjusting section 123 and the time calculating section 131, and in a case where the jitter accumulation value reaches the lower limit value DL, the comparing section 122 outputs a control value corresponding to the lower limit value DL to the gain adjusting section 123 and the time calculating section 131. The control values are correction values for correcting a frequency error, in which the control value corresponding to the upper limit value DH and the control value corresponding to the lower limit value DL have different signs. For example, if the control value corresponding to the upper limit value DH is “−1”, the control value corresponding to the lower limit value DL is “+1”.

The gain adjusting section 123 performs a gain, adjustment that is a process of assigning a predetermined gain to the control value that is an output of the comparing section 122. In a case where it is desired that the VCO control voltage is greatly changed by one-time reaching with respect to the upper limit value DH or the lower limit value DL, the gain is set to be large, and in a case where it is desired that the VCO control voltage is slightly changed, the gain is set to be small. The gain value of the gain adjusting section 123 may he set to a desired value by a user input.

The control voltage generating section 124 accumulates the control value after gain adjustment that is an output of the gain adjusting section 123 to generate the VCO control voltage for correcting a frequency error, and outputs the result to the DAC and LPF 125.

The DAC and LPF 125 converts (D/A-converts) the digital VCO control voltage from the control voltage generating section 124 into an analog signal, and further performs a low pass filtering process for output.

In a case where the jitter accumulation value does not reach any one of the upper limit value DH or the lower limit value DL, in other words, in a case where the jitter accumulation value is a value between the upper limit value DH and the lower limit value DL, nothing is output to the gain adjusting section 123 from the comparing section 122. Accordingly, in a case where the jitter accumulation value does not reach any one of the upper limit value DH or the lower limit value DL, the VCO control voltage that is the same as the immediately previous VCO control voltage is continuously output to the clock generating section 4, without change in the operation of the gain adjusting section 123 or the DAC and LPF 125.

Next, the frequency synchronization determining section 112 will be described. Here, repetitive description about the jitter accumulation section 121 and the comparing section 122 will be appropriately omitted.

The jitter accumulating section 121 that forms the frequency synchronization determining section 112 calculates the jitter accumulation value and outputs the result to the comparing section 122, and also calculates a jitter width J (=maximum value−minimum value). For example, the jitter accumulating section 121 stores the jitter amounts that are sequentially supplied from the jitter amount calculating section 14 by a predetermined number of samples that are immediately next to each other, and calculates the jitter width J using a maximum value and a minimum value of the samples. The calculated jitter width J is supplied to the frequency error calculating section 132.

The case where the upper limit value DH and the lower limit value DL are set in advance in the comparing section 122 has been described, but the jitter width J that is calculated by the jitter accumulating section 121 may be also supplied to the comparing section 122, and the comparing section 122 may set the upper limit value DH and the lower limit value DL on the basis of the calculation result of the jitter width J.

The time calculating section 131 obtains the control value corresponding to the upper limit value DH or the lower limit value DL supplied from the comparing section 122 as an arrival signal indicating that the jitter accumulation value reaches any one threshold value of the upper limit value DH or the lower limit value DL. The time calculating section 131 calculates an arrival time Δt from the time, when the arrival signal is supplied from the comparing section 122 and the time when the immediately previous arrival signal is supplied, to the time when the arrival signal reaches one threshold value of the upper limit value DH and the lower limit value DL from the other threshold value thereof. The time calculating section 131 has a memory to which the time when the immediately previous arrival signal is supplied is stored. The calculated arrival time Δt is supplied to the frequency error calculating section 132.

An interval between the upper limit value DH and the lower limit value DL set in the comparing section 122 is set in advance and stored in the frequency error calculating section 132. The frequency error calculating section 132 calculates a frequency error using the jitter width J supplied from the jitter accumulating section 121, the arrival time Δt supplied from the time calculating section 131, and the interval (time) between the upper limit value DH and the lower limit value DL. Further, the frequency error calculating section 132 determines whether frequency synchronization is established on the basis of the calculated frequency error. Specifically, the frequency error calculating section 132 determines that the frequency synchronization is established in a case where the calculated frequency error is within a predetermined threshold value FTH 1. Further, in a case where it is determined that the frequency synchronization is established, the frequency error calculating section 132 outputs a synchronization determination signal to the timepiece section 6.

In a case where the synchronization determination signal is supplied from the frequency error calculating section 132, the timepiece section 6 starts rewriting of a counted value based on a transmission time of a synchronization packet from the transmission time recording section 13, and outputs the counted value after rewriting to the synchronization signal generating section 7.

A process of the frequency error detecting section 111 will be further described.

### [Relationship Between Jitter Accumulation Value and Arrival Delay Time]

In the receiving apparatus 100 of FIG. 2, in the frequency error detecting section 111, the jitter accumulation value is calculated, and it is then detected whether the calculated jitter accumulation value reaches any one of the upper limit value DH or the lower limit value DL.

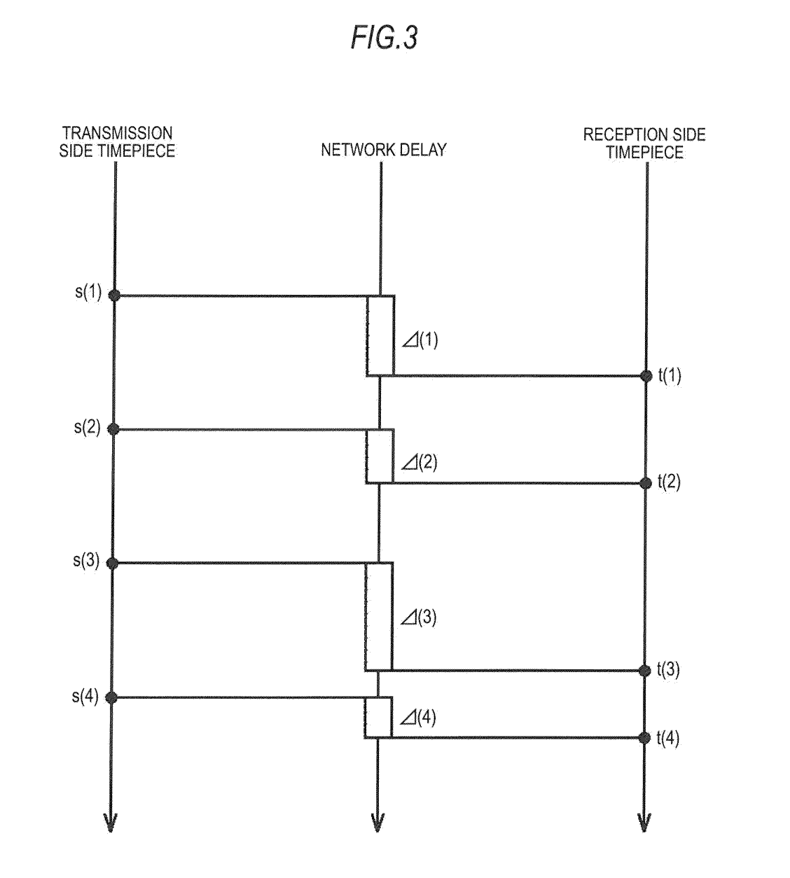

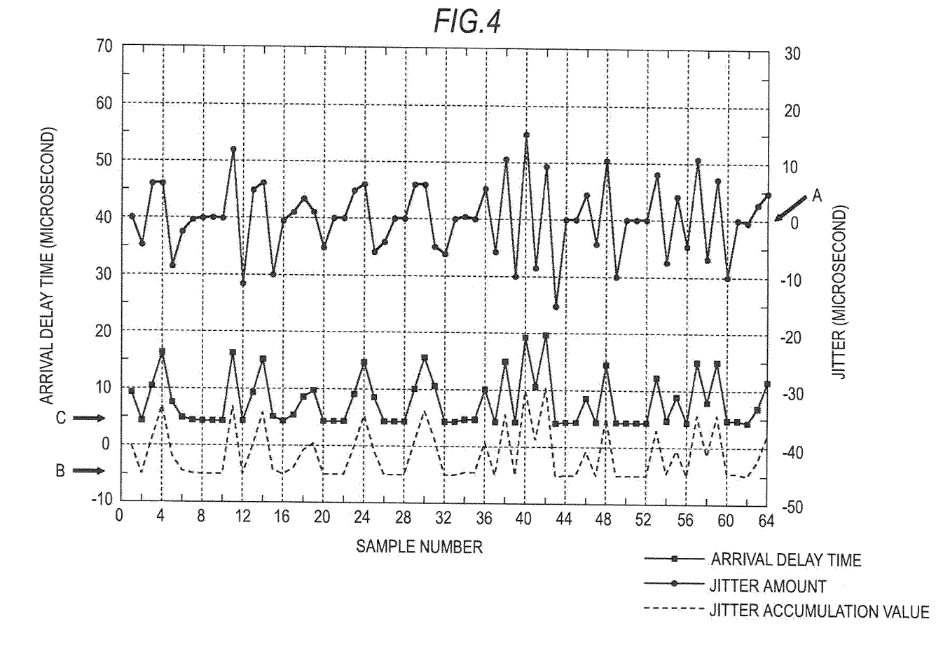

Here, with reference to FIGS. 3 and 4, the relationship between the jitter accumulation value and a delay time of arrival (hereinafter, referred to as arrival delay time) generated on a network will be described. The arrival delay time depends on the length of a LAN cable, a configuration of a network such as a switch, and the size of the synchronization packet, but it is hereinafter assumed that the arrival delay time is generated due to the switch, for simplicity of description.

Characteristics of arrival delay times Δ(1), Δ(2), of the synchronization packet will be described with reference to FIG. 3. Here, the number in ( ) represents a sample number of the synchronization packet.

In a network that is configured so that the synchronization packet and a different packet such as a video signal packet are transmitted from the same output port of the switch, the transmission of the synchronization packet is immediately performed as it is in a case where the transmission of the synchronization packet does not overlap with the transmission of the other packet. However, in a case where the transmission of the synchronization packet overlaps with the transmission of the other packet, the transmission of the synchronization packet is postponed. The output standby time depends on the time necessary for the transmission of the different packet, which is not constant. Thus, delay variations expressed by the following Formula (2), in addition to a constant passage delay, are observed on the reception side.

$$t ( 1 ) - s ( 1 ) = Δ ( 1 ) + offset ( 1 ) \\ t ( 2 ) - s ( 2 ) = Δ ( 2 ) + offset ( 2 ) \\ t ( 3 ) - s ( 3 ) = Δ ( 3 ) + offset ( 3 ) \\ t ( 4 ) - s ( 4 ) = Δ ( 4 ) + offset ( 5 ) \\ … \qquad ( 2 )$$

Timepieces on the transmission side and the reception side are different from each other in counted values (=time) and a progression rate (=length per second), offset (1), offset (2), offset (3), offset (4), and the like take different values. However, if offset (1)≅offset (2)≅offset (3)≅offset (4), and so on is satisfied under a certain condition, the jitter amounts expressed by the following Formula (3) are observed on the reception side. For example, the certain condition includes a condition that a frequency lock of the clock frequency is achieved prior to time synchronization, or a condition that the synchronization packet is generated at a short time interval to such a degree that an offset difference for each sample is sufficiently small.

$$t ( 2 ) - s ( 2 ) - ( t ( 1 ) - s ( 1 ) ) = Δ ( 2 ) - Δ ( 1 ) \\ t ( 3 ) - s ( 3 ) - ( t ( 2 ) - s ( 2 ) ) = Δ ( 3 ) - Δ ( 2 ) \\ t ( 4 ) - s ( 4 ) - ( t ( 3 ) - s ( 3 ) ) = Δ ( 4 ) - Δ ( 3 ) \\ … \qquad ( 3 )$$

If the jitter amounts expressed by the above Formula (3) are accumulated and summed, the following Formula (4) is obtained.

$$\{ t ( 2 ) - s ( 2 ) - ( t ( 1 ) - s ( 1 ) ) \} + \{ t ( 3 ) - s ( 3 ) - ( t ( 2 ) - s ( 2 ) ) \} = \{ Δ ( 2 ) - Δ ( 1 ) \} + \{ Δ ( 3 ) - Δ ( 2 ) \} = Δ ( 3 ) - Δ ( 1 ) \\ \{ t ( 2 ) - s ( 2 ) - ( t ( 1 ) - s ( 1 ) ) \} + \{ t ( 3 ) - s ( 3 ) - ( t ( 2 ) - s ( 2 ) ) \} + \{ t ( 4 ) - s ( 4 ) - ( t ( 3 ) - s ( 3 ) ) \} = \{ Δ ( 2 ) - Δ ( 1 ) \} + \{ Δ ( 3 ) - Δ ( 2 ) \} + \{ Δ ( 4 ) - Δ ( 3 ) \} = Δ ( 4 ) - Δ ( 1 ) … \qquad ( 4 )$$

As is obvious from Formula (4), due to the accumulation and addition of the jitter amounts, as expressed by the following Formula (5), variation of the arrival delay time for each sample that is shifted by Δ(1) is obtained.

$${\sum }_{i = 2}^{n} \{ t ( i ) - s ( i ) - ( t ( i - 1 ) - s ( i - 1 ) ) ] = Δ ( n ) - Δ ( 1 ) \qquad ( 5 )$$

FIG. 4 shows a measurement example of the jitter amounts, a jitter accumulation value and an arrival delay time in a case where an offset of timepieces on the transmission side and the reception side is 0.

The jitter amounts capable of being measured on the reception side vary for each sample of synchronization packets around A=0 microsecond. The jitter accumulation value obtained by accumulating the jitter amounts takes a minimum value B, and varies in the same manner as the arrival delay time that cakes a minimum value C. In this example, since B is about −5 microseconds and C is about +4 microseconds, a value obtained by correcting (shifting) the jitter accumulation value by +9 microseconds in the entire samples becomes the arrival delay time for each sample.

As described with reference to FIG. 1, the jitter amount calculated by the jitter amount calculating section 14 corresponds to a combination of the clock frequency error on the transmission side and the reception side and the influence of the arrival delay time variation, under a circumstance where the influence of the arrival delay time variation of the synchronization packet on the network is present.

In other words, the jitter accumulation value that is obtained by accumulation of the jitter amounts is divided into a part corresponding to accumulation of the clock frequency errors on the transmission side and the reception side, and a part corresponding to accumulation of the arrival delay times. Further, the part corresponding to the accumulation of the arrival delay times has a characteristic of staying in a value in a certain range, as understood from FIG. 4.

Accordingly, even though the upper limit value DH and the lower limit value DL corresponding to the range where the part, corresponding to the accumulation of the arrival delay times, stays are set, if a state where the jitter accumulation value is beyond the upper limit value DH or the lower limit value DL occurs, this is based on the part corresponding to the accumulation of the clock frequency errors on the transmission side and the reception side.

As described above, in a case where the clock frequency error is present on the transmission side and the reception side, a state where the jitter accumulation value calculated by the jitter accumulating section 121 is beyond the range between the upper limit value DH and the lower limit value DL occurs. On the other hand, in a case where the clock frequency error is not present on the transmission side and the reception side, the state where the jitter accumulation value calculated by the jitter accumulating section 121 is beyond the range between the upper limit value DH and the lower limit value DL does not occur.

In other words, in a case where the clock frequency error is not present on the transmission side and the reception side, the offset of the timepieces on the transmission side and the reception side reaches a state of offset (1)=offset (2)=offset (3)=offset (4), and so on.

However, in a case where the clock frequency error is present on the transmission side and the reception side, offset (1)<offset (2)<offset (3)<offset (4), and so on, or offset (1)>offset (2)>offset (3)>offset (4), and so on. If the state of offset (1)<offset (2)<offset (3)<offset (4), and so on is generated, the jitter accumulation value calculated by the jitter accumulating section 121 reaches the upper limit value DH after a predetermined time elapses. Further, if the state of offset (1)>offset (2)>offset (3)>offset (4), and so on is generated, the jitter accumulation value calculated by the jitter accumulating section 121 reaches the lower limit value DL after predetermined time elapses.

As described above, the VCO control voltage is adjusted so that the jitter accumulation value calculated by the jitter accumulating section 121 is not beyond the range between the predetermined upper limit value DH and the lower limit value DL, and is able to remove the clock frequency error. That is, it is possible to realize frequency synchronization with high accuracy while removing the influence of jitter that greatly varies due to topology of a network, performance of a switch that forms the network, and a traffic state.

### [Description of Frequency Synchronization Control]

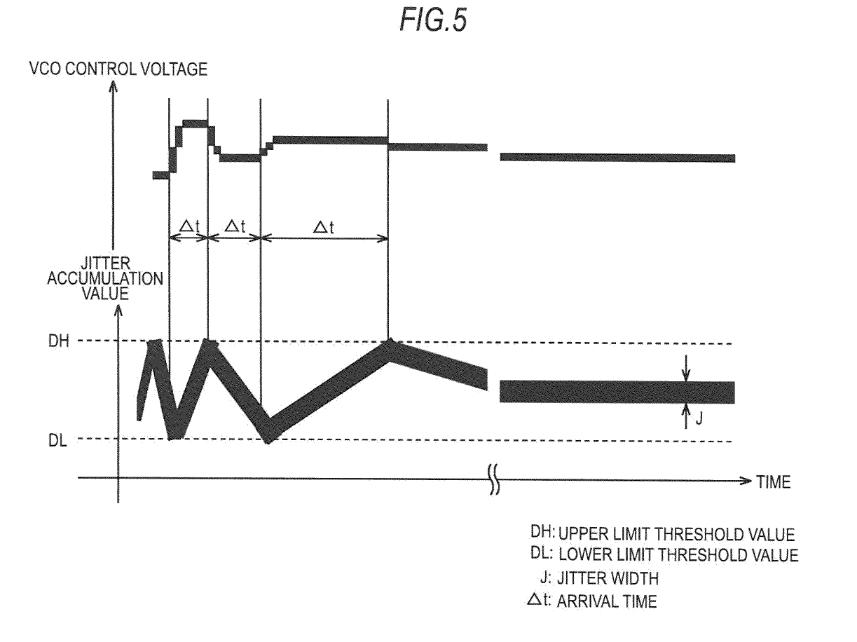

FIG. 5 shows an operation example of frequency synchronization control in the receiving apparatus 100.

A frequency lock loop circuit is configured by the reception time recording section 12, the jitter amount calculating section 14, the frequency error detecting section 111, the clock generating section 4, and the counter 5.

The upper limit value DH and the lower limit value DL are set in advance in the comparing section 122 of the frequency error detecting section 111. The upper limit value DH and the lower limit value DL are determined according to how much delay time and delay fluctuation (the synchronization processing apparatus of) the receiving apparatus 100 guarantees.

The comparing section 122 outputs a control value for decreasing the clock frequency in a case where the jitter accumulation value reaches the upper limit value DH, and outputs a control value for increasing the clock frequency in a case where the jitter accumulation value reaches the lower limit value DL. Accordingly, at the time point when the jitter accumulation value reaches the upper limit value DH or the lower limit value DL, a frequency lock loop control is performed to supply the VOC control voltage for changing the clock frequency in a reverse direction.

The jitter accumulation value repeats the reversal at the time point when the jitter accumulation value reaches the upper limit value DH or the lower limit value DL, and is then stabilized after a certain time elapses. Since the frequency error of the receiving apparatus 100 is decreased whenever the reversal is repeated, the arrival time Δt until the jitter accumulation value is changed from one threshold value of the upper limit value DH or the lower limit value DL to the other threshold value thereof gradually becomes long.

### [Description of Frequency Synchronization Determination Process]

Next, a process of the frequency synchronization determining section 112 will be described.

As described above, in a case where the clock frequency error is present on the transmission side and the reception side, the jitter accumulation value calculated by the jitter accumulating section 121 fluctuates, and a state where the jitter accumulation value reaches the upper limit value DH or the lower limit value DL occurs. In other words, the accumulation of the frequency errors for a predetermined time appears as a change in the output of the jitter accumulating section 121. For example, in a case where the frequency error is +1 ppm, this means that the output of the jitter accumulating section 121 is changed by +1 microsecond at 1 second. Thus, by dividing the change in the output of the jitter accumulating section 121 by time necessary for the change, it is possible to obtain the frequency error.

The time calculating section 131 calculates the arrival time Δt until the jitter accumulation value is changed from one threshold value of the upper limit value DH and the lower limit value DL to the other threshold value thereof, using the fact that the comparing section 122 outputs the control value at the time point when the jitter accumulation value reaches the upper limit value DH or the lower limit value DL.

The change in the output of the jitter accumulating section 121 corresponds to a value obtained by subtracting the jitter width J from the interval between the upper limit value DH and the lower limit value DL. For example, in a case where the jitter width J is obtained as J=70 [ns] from a measurement result and the interval between the upper limit value DH and the lower limit value DL is set to 170 [ns], the jitter accumulation value is changed from one threshold value to the other threshold with a change of 100 [ns] in the jitter accumulation value. A value obtained by dividing the change of 100 [ns] in the jitter accumulation value by the arrival time Δt, that is, 100×10⁻⁹/Δt corresponds to a frequency error at the time point.

In the present embodiment, the time calculating section 131 calculates the arrival time Δt until the jitter accumulation value is changed from one threshold value of the upper limit value DH and the lower limit value DL to the other threshold value thereof, using the fact that the control value is output at the time point when the jitter accumulation value reaches the upper limit value DH or the lower limit value DL. However, since if the change in the output of the jitter accumulating section 121 is divided by the time necessary for the change, the frequency error is calculated, the frequency error may be calculated using points other than the upper limit value DH and the lower limit value DL. That is, using a time Δt from a first time to a second time in the frequency loop control, and variation of the output of the jitter accumulating section 121 between two points from the first time to the second time, it is possible to calculate the frequency error. For example, it is possible to calculate the frequency error using the time Δt from the first time that is a first jitter accumulation value between the upper limit value DH and the lower limit value DL to the second time that is a second jitter accumulation value between the upper limit value DH and the lower limit value DL.

### [Flow of Frequency Synchronization Control Process]

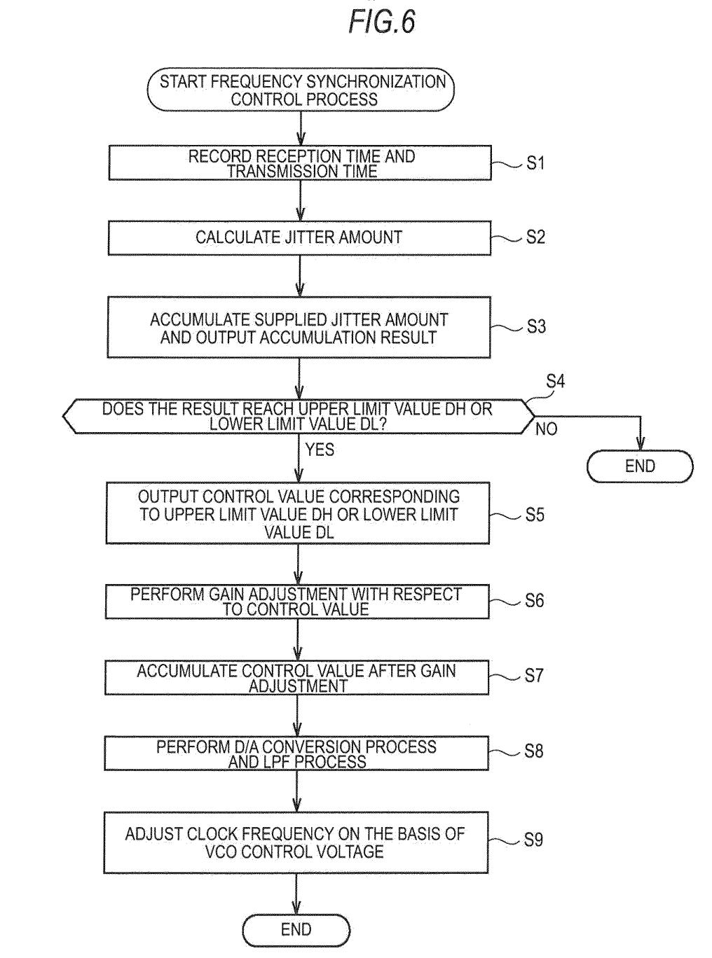

FIG. 6 is a flowchart illustrating a frequency synchronization control process performed by the receiving apparatus 100. This process is performed whenever the synchronization packet is received by the synchronization packet receiving section 11 of the receiving section 100.

If the synchronization packet is received in the synchronization packet receiving section 11, in step S1, the reception time recording section 12 and the transmission time recording section 13 record a reception time and a transmission time. That is, the reception time recording section 12 records a counted value of the counter 5 at the time point when the synchronization packet is received as the reception time. The transmission time recording section 13 extracts the transmission time included in the synchronization packet supplied from the synchronization packet receiving section 11 and records the result.

In step S2, the jitter amount calculating section 14 calculates the jitter amount, using Formula (1), on the basis of the reception time and the transmission time of two adjacent synchronization packets, recorded in the reception time recording section 12 and the transmission time recording section 13. The calculated jitter amount is output to the jitter accumulating section 121.

In step S3, the jitter accumulating section 121 accumulates the jitter amounts supplied from the jitter amount calculating section 14, and outputs a jitter accumulation value that is the accumulation result to the comparing section 122.

In step S4, the comparing section 122 determines whether the jitter accumulation value from the jitter accumulating section 121 reaches any one of the upper limit value DH or the lower limit value DL.

In step S4, in a case where the jitter accumulation value does not reach any one of the upper limit value DH and the lower limit value DL, the process ends.

On the other hand, in step S4, in a case where the jitter accumulation value reaches any one of the upper limit value DH or the lower limit value DL, the process goes to step S5.

In step S5, the comparing section 122 outputs an control value corresponding to the upper limit value DH or the lower limit value DL to the gain adjusting section 123. That is, in a case where the jitter accumulation value reaches the upper limit value DH, the comparing section 122 outputs an control value corresponding to the upper limit value DH to the gain adjusting section 123. On the other hand, in a case where the jitter accumulation value reaches the lower limit value DL, the comparing section 122 outputs an control value corresponding to the lower limit value DL to the gain adjusting section 123.

In step S6, the gain adjusting section 123 performs a gain adjustment of assigning a predetermined gain to the control value that is the output from the comparing section 122.

In step S7, the control voltage generating section 124 accumulates the control values after the gain adjustment, that are the output of the gain adjusting section 123, to generate the VCO control voltage for correcting the frequency error, and outputs the result to the DAC and LPF 125.

In step S8, the DAC and LPF 125 perform a D/A conversion process of converting the digital VCO control voltage generated by the control voltage generating section 124 to an analog signal and a low pass filtering process for the VCO control voltage after D/A conversion process.

In step S9, the clock generating section 4 generates a clock CLK for adjusting a clock frequency on the basis of the VCO control voltage from the DAC and DPF 125. The clock frequency after being adjusted is output to the counter 5, the timepiece section 6, the synchronization signal generating section 7 and the like, and then the process ends.

The above-described process is executed whenever the synchronization packet is received by the receiving apparatus 100 in FIG. 2.

In the receiving apparatus 100, the noise removal filter as in the receiving apparatus in the related art is not provided, and the jitter accumulation value obtained by accumulating the calculated jitter amounts is compared with the upper limit value DH and the lower limit value DL to generate the VCO control voltage. Accordingly, in the receiving apparatus 100, even in a case where in the related art receiving apparatus, noise of the network is large, and thus, it is difficult to remove the noise if plural stages of filters are not provided and in a case where a leading-in time is increased, it is possible to effectively establish frequency synchronization. That is, according to the receiving apparatus 100, it is possible to perform frequency synchronization with high accuracy in a shorter time.

### [Frequency Synchronization Determination Process Flow]

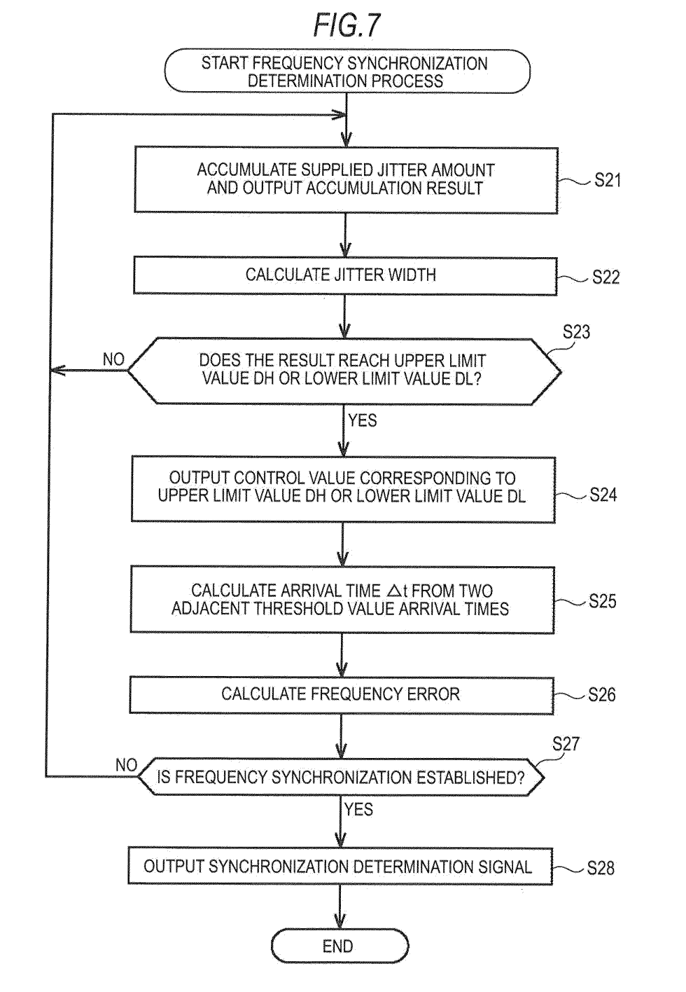

FIG. 7 a flowchart, illustrating a frequency synchronization determination process performed by the frequency synchronization determining section 112 of the receiving apparatus 100. This process starts at the time when the jitter amount is initially supplied to the jitter accumulating section 121, for example.

Operations of steps S21, S23 and S24 are operations that are performed as the same process as the frequency synchronization control process in the jitter accumulating section 121 and the comparing section 122 that are shared with the frequency error detecting section 111. That is, the operations of steps S21, S23 and S24 are the same as the operations of steps S3, S4 and S5 of the above-described frequency synchronization control process.

In step S22, the jitter accumulating section 121 calculates the jitter width J from the maximum value and the minimum value of the jitter amounts stored in the inside thereof, and outputs the result to the frequency error calculating section 132. The operations of steps S21 and S22 may be performed in the opposite order or may be performed in parallel.

In step S25, the time calculating section 131 calculates the arrival time Δt from the two adjacent threshold arrival times. That is, the time calculating section 131 calculates the arrival time Δt from the current time when an arrival signal is supplied and the time when the immediately previous arrival signal is supplied.

In step S26, the frequency error calculating section 132 calculates the frequency error using the jitter width J supplied from the jitter accumulating section 121, the arrival time Δt supplied from the time calculating section 131, and the interval (time) between the upper limit value DH and the lower limit value DL.

In step S27, the frequency error calculating section 132 determines whether frequency synchronization is established on the basis of the calculated frequency error. Specifically, the frequency error calculating section 132 determines whether the calculated frequency error is present within a predetermined threshold value FTH1.

In step S27, in a case where it is determined that the frequency synchronization is not yet established, the process returns to step S21, and then, the operations of the above-mentioned steps S21 to S27 are repeated.

On the other hand, in step S27, in a case where it is determined that frequency synchronization is established, the processes goes to step S28, and then, the frequency error calculating section 132 outputs a frequency determination signal to the timepiece section 6. Then, the process ends.

The frequency synchronization determination process is executed in the receiving apparatus 100, as described above.

Since the jitter accumulation value corresponds to a value obtained by shifting the arrival delay time and has a characteristic that stays in a value in a certain range, the arrival of the jitter accumulation value to the threshold value depends on the influence of the frequency error. Since the frequency synchronization determining section 112 computes the jitter accumulation value, calculates the frequency error using the change amount of output thereof, and determines whether the frequency synchronization is established, it is possible to perform the frequency synchronization determination while excluding the influence of variation of the arrival, delay time of the synchronization packet on the network. Accordingly, it is possible to determine frequency synchronization with high accuracy.

### [Configuration Example of PTP Correspondence]

In the above-mentioned example, the jitter amount calculated by the jitter amount calculating section 14 using Formula (1) corresponds to the jitter amount calculated using a one-step Sync message of IEEE1588 PTP (Precision Time Protocol), which is not the IEEE1588 standard.

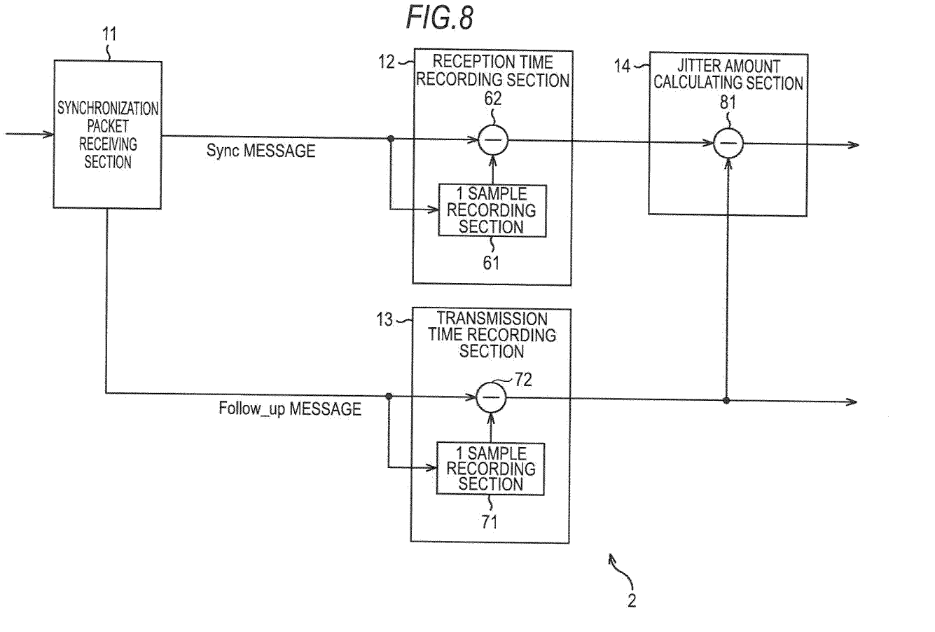

However, as each section of the synchronization packet processing section 2 employs a configuration shown in FIG. 8, it is possible to match with the IEEE1588 PTP in which the jitter amount is calculated using a Sync message and a Follow_up message.

That is, FIG. 8 shows a configuration example of the synchronization packet processing section 2 in a case where it matches with the IEEE1588 PTP.

The synchronization packet receiving section 11 receives the Sync message and the Follow_up message, and outputs the Sync message to the reception time recording section 12 and outputs the Follow_up message to the transmission time recording section 13.

The reception time recording section 12 includes a one-sample recording section 61 and a subtracter 62.

The one-sample recording section 61 records a Sync reception time stamp of the Sync message that is immediately previously transmitted in view of time. The subtracter 62 computes the difference between the Sync reception time stamp of the currently received Sync message supplied from the synchronization packet receiving section 11 and the immediately previous Sync reception time stamp recorded in the one-sample recording section 61, and outputs the result to the jitter amount calculating section 14.

The transmission time recording section 13 includes a one-sample recording section 71 and a subtracter 72.

The one-sample recording section 71 records a Follow_up transmission time stamp of the Follow_up message that is immediately previously transmitted in view of time. The subtracter 72 computes the difference between the Follow_up transmission time stamp of the currently received Follow_up message supplied from a synchronization packet receiving section 11 and the immediately previous Follow_up transmission time stamp recorded in the one-sample recording section 71, and outputs the result to the jitter amount calculating section 14.

The jitter amount calculating section 14 includes a subtracter 81. The subtracter 81 subtracts the Follow_up transmission time stamp difference supplied from the transmission time recording section 13 from the Sync reception time stamp difference supplied from the reception time recording section 12, to calculate the jitter amount for output.

With such a configuration, the receiving apparatus 100 is able to calculate the jitter amount using the Sync message and the Follow_up message of two stamp types, and is able to match with the IEEE1588 PTP.

### 2. Second Embodiment

### [Block Diagram of Configuration of Receiving Apparatus]

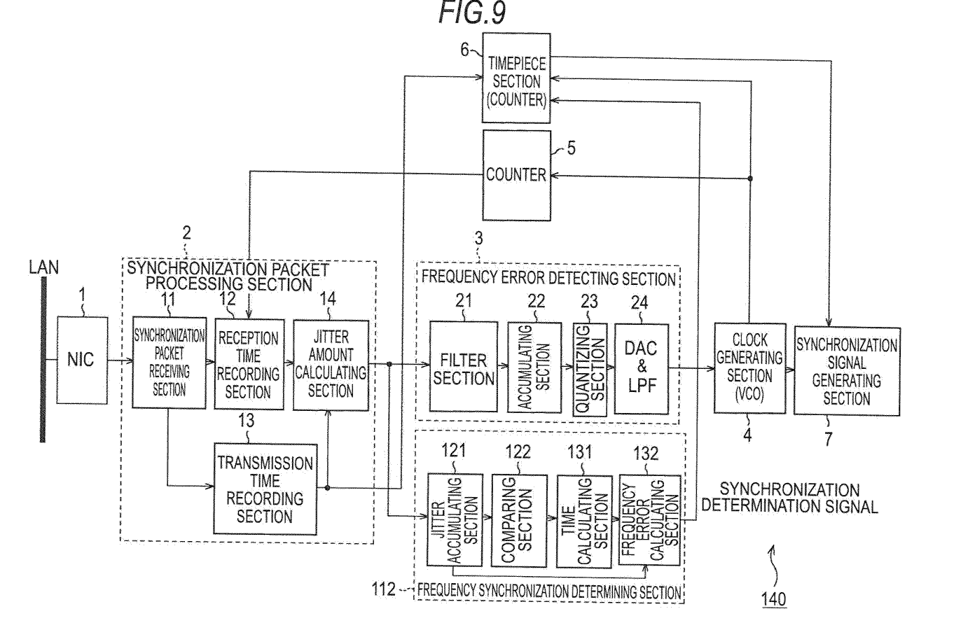

FIG. 9 is a block diagram illustrating a second embodiment of a receiving apparatus.

A receiving apparatus 140 in FIG. 9 has a configuration that includes the frequency synchronization determining section 112 in FIG. 2 instead of the frequency synchronization determining section 8 of the receiving apparatus in the related art in FIG. 1. The jitter amount calculated by the jitter amount calculating section 14 of the synchronization packet processing section 2 is supplied to both of the filter section 21 of the frequency error detecting section 3 and the jitter accumulating section 121 of the frequency synchronization determining section 112.

In the above-described first embodiment, when the jitter accumulation value reaches the upper limit value DH or the lower limit value DL, the frequency synchronization control is employed to generate the VCO control voltage for converting the clock frequency in the reversed direction.

However, as shown in FIG. 9, with respect to the frequency synchronization control, it is possible to employ a configuration in which the jitter accumulation value is only used for the frequency synchronization determination process using a method of removing noise of the calculated jitter amount, as in the related art. In this way, the frequency synchronization determination process that uses the jitter accumulation value may be combined with an arbitrary frequency synchronization control method and used.

### 3. Third Embodiment

### [Block Diagram of Configuration of Receiving Apparatus]

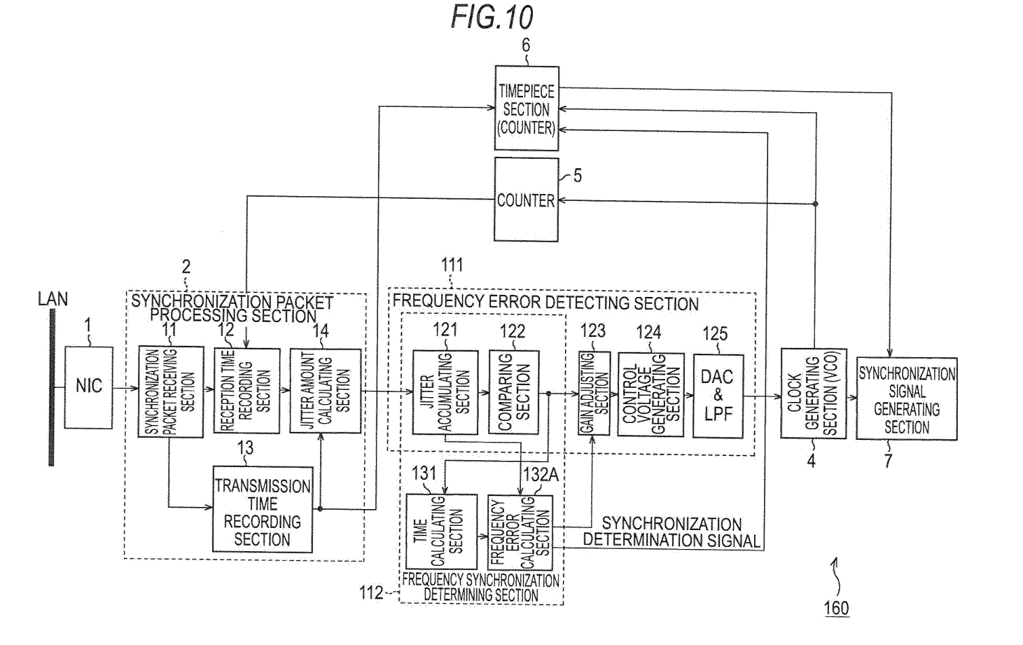

FIG. 10 is a block diagram illustrating a third embodiment of a receiving apparatus.

In FIG. 10, the same reference numerals are given to sections corresponding to those in FIG. 2, and repetitive description thereof will be appropriately omitted.

A receiving apparatus 160 in FIG. 10 is different from the receiving apparatus 100 in FIG. 2 only in a frequency error calculating section 132A.

The frequency error calculating section 132A controls a process of calculating a frequency error in a similar way to the frequency error calculating section 132, and controls the gain (the amount of gain) of the gain adjusting section 123 according to the calculated frequency error. That is, the frequency error calculating section 132A changes the gain of the gain adjusting section 123 according to the calculated frequency error so that the gain is increased when the frequency error is large and the gain is decreased when the frequency error is small. The gain adjusting section 123 performs gain adjustment according to the gain set by the frequency error calculating section 132A.

### 4. Fourth Embodiment

### [Block Diagram of Configuration of Receiving Apparatus]

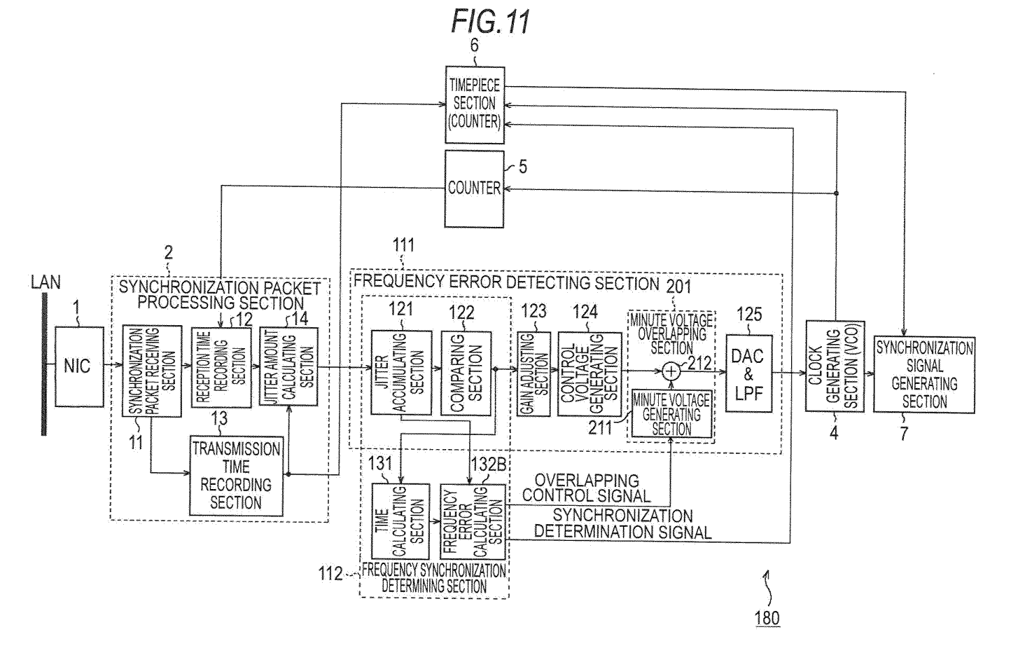

FIG. 11 is a block diagram illustrating a fourth embodiment of a receiving apparatus.

In FIG. 11, the same reference numerals are given to sections corresponding to those in FIG. 2, and repetitive description thereof will be appropriately omitted.

A receiving apparatus 180 of FIG. 11 is different from the receiving apparatus 100 of FIG. 2 in that a frequency error calculating section 132B is provided instead of the frequency error calculating section 132 and a minute voltage overlapping section 201 is newly provided between the control voltage generating section 124 and the DAC and LPF 125. The minute voltage overlapping section 201 includes a minute voltage generating section 211 and an adder 212.

The frequency error calculating section 132B determines whether the frequency synchronization is established according to the calculated frequency error, in a similar way to the frequency error calculating section 132. Further, in a case where it is determined that the frequency synchronization is established, the frequency error calculating section 132B outputs a synchronization determination signal to the timepiece section 6, and outputs an overlapping control signal that allows an overlapping process to the minute voltage generating section 211 of the minute voltage overlapping section 201.

In a case where the overlapping control signal that allows the overlapping process is supplied from the frequency error calculating section 132B, the minute voltage generating section 211 of the minute voltage overlapping section 201 generates a periodic minute voltage, and outputs the result to the adder 212. The adder 212 adds (overlaps) the minute voltage from the minute voltage generating section 211 to the VCO control voltage from the control voltage generating section 124, and outputs the result to the DAC and LPF 125.

For example, if it is determined that the frequency synchronization is established with a frequency error Δf, the minute voltage generating section 211 periodically adds a value ([−Δf×2/VCO sensitivity] ppm) obtained by dividing an opposite sign of the frequency error Δf by a VCO sensitivity twice and a minute displacement voltage (minute voltage) of 0 ppm. Here, the VCO sensitivity represents the amount of frequency displacement per step. For example, if the frequency error Δf is −0.01 ppm when it is determined that the frequency synchronization is established by the frequency error calculating section 132B, the minute voltage overlapping section 201 periodically adds [+0.02 ppm] and [0 ppm]. In this case, the clock frequency generated by the clock generating section 4 has an error of +0.01 ppm to −0.01 ppm, which is based on the assumption that the error is an error in a range where requirement accuracy is satisfied.

### [Description of Frequency Synchronization Determination Process]

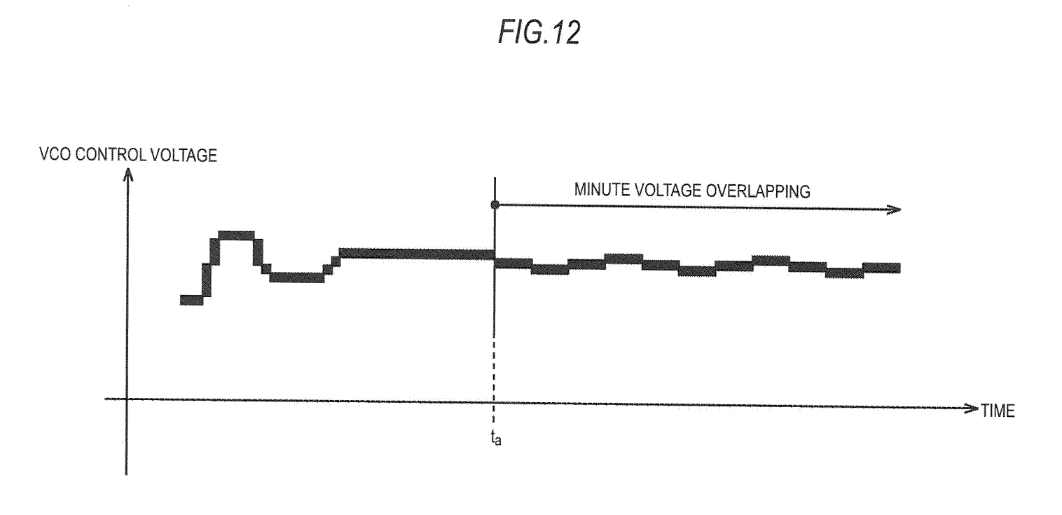

FIG. 12 shows an example of the VCO control voltage input to the DAC and LPF 125, in the fourth embodiment.

In the example of FIG. 12, at a time tₐ, the overlapping control signal that allows the overlapping process is supplied to the minute voltage generating section 211, and the periodic minute voltage generated by the minute voltage generating section 211 overlaps with the VCO control voltage from the control voltage generating section 124 from the time tₐ.

In the frequency synchronization determination process according to the fourth embodiment, in step S27 of FIG. 7, the frequency error calculating section 132B outputs the synchronization determination signal to the timepiece section 6, and also outputs the overlapping control signal that allows the overlapping process in the minute voltage generating section 211 of the minute voltage overlapping section 201. The other operations of the frequency synchronization determination process according to the fourth embodiment are the same as in the frequency synchronization determination process according to the first embodiment described with reference to FIG. 7.

The minute voltage overlapped by the minute voltage overlapping section 201 changes the clock frequency, but the change in the clock frequency due to the minute voltage does not affect a subsequent comparison process of the comparing section 122 due to a frequency lock loop control. In other words, it is necessary that the cycle of the minute voltage overlapped by the minute voltage overlapping section 201 be a cycle that is equal to or shorter than a wonder cycle that does not affect the subsequent comparison process due to the frequency lock loop control.

On the other hand, in a case where the overlapping control signal that allows the overlapping process is not supplied from the frequency error calculating section 132B, or in a case where an overlapping control signal that does not allow the overlapping process is supplied from the frequency error calculating section 132B, the minute voltage generating section 211 stops the output of the minute voltage to the adder 212. In this case, the adder 212 outputs the VCO control voltage from the control voltage generating section 124 to the DAC and LPF 125 as it is.

In the frequency synchronization control that uses the change in the accumulation value (jitter accumulation value) of the jitter amount used in the first embodiment, it is possible to reduce the remaining error of the frequency. However, as the remaining error of the frequency is reduced, time taken for the frequency control, specifically, the arrival time Δt until the jitter accumulation value is changed from one threshold value of the upper limit value DH and the lower limit value DL to the other threshold value thereof is gradually increased. At the arrival time Δt, a clock frequency having a certain frequency error (remaining error) is continuously output. Thus, even though the frequency error is slight, in a case where the frequency error is continuously accumulated for a long time, it is difficult to ignore the size.

Thus, in a case where the frequency error is a predetermined value or less, the receiving apparatus 180 of the fourth embodiment overlaps the periodic minute voltage with the VCO control voltage from the control voltage generating section 124, to thereby forcibly exclude remaining in the state of having the frequency displacement in the same direction for a long time. Thus, the clock frequency generated by the clock generating section 4 becomes accurate, and the synchronization signal generated in the synchronization signal generating section 7 becomes accurate. That is, it is possible to constantly set the accumulation value of the synchronization signal generated by the synchronization signal generating section 7 to be equal to or smaller than a predetermined value. For example, in a case where the synchronization signal generating section 7 generates a video synchronization signal, the accumulation value of time errors of the synchronization signal appears as displacement of the phase of the generated synchronization signal. Here, it is able to suppress the displacement of the phase in a predetermined, range.

Further, in the receiving apparatus 180, by overlapping the periodic minute voltage with the VCO control voltage from the control voltage generating section 124, it is possible to determine whether the frequency synchronization is established using a threshold value FTH2 larger than the threshold value FTH1 of the receiving apparatus 100 that does not overlap with the minute voltage, and thus, it is possible to rapidly establish the frequency synchronization compared with the receiving apparatus 100.

### [Flow of Frequency Synchronization Control Process]

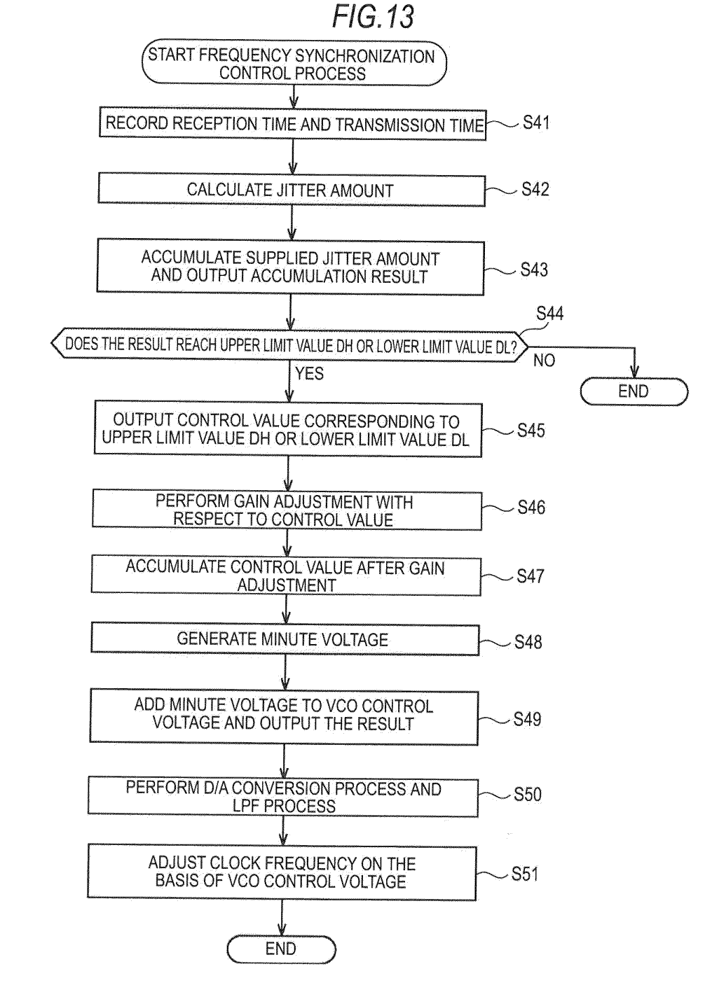

FIG. 13 is a flowchart illustrating the frequency synchronization control process that uses the receiving apparatus 180, after the overlapping control signal that allows the overlapping process is supplied. This process is executed whenever the synchronization packet is received by the synchronization packet receiving section 11 after the overlapping control signal is supplied, for example.

Steps S41 to S47 of the frequency synchronization control process in FIG. 13 correspond to steps S1 to S7 of the frequency synchronization control process in FIG. 6, and steps S50 and S51 of the frequency synchronization control process in FIG. 13 correspond to steps S8 and S9 of the frequency synchronization control process in FIG. 6. In other words, the frequency synchronization control process in FIG. 13 is obtained by adding operations of steps S48 and S49 between steps S7 and S8 of the frequency synchronization control process in FIG. 6.

in step S48 in FIG. 13, the minute voltage generating section 211 of the minute voltage overlapping section 201 generates a periodic minute voltage, and supplies the result to the adder 212. The value of the generated minute voltage may be set to a specific value ([−(FTH2)×2/VCO sensitivity] ppm) that is set in advance on the basis of the threshold value FTH2 (>frequency error Δf) in which it is determined that the frequency synchronization is established, or a value ([−(Δf))×2/VCO sensitivity] ppm) based on the current frequency error Δf obtained from the frequency error calculating section 132.

In step S49, the adder 212 adds the minute voltage supplied from the minute voltage generating section 211 to the VCO control voltage from the control voltage generating section 124, and outputs the result to the DAC and LPF 125.

The frequency synchronization control process after the overlapping control signal that allows the overlapping process is supplied is executed as follows.

In the receiving apparatus 180 of the fourth embodiment, it is possible to realize the frequency synchronization determination with high accuracy, and to rapidly perform synchronization compared with the first embodiment.

The gain adjustment function according to the frequency error of the third embodiment may be added to the fourth embodiment. That is, the frequency error calculating section 132B controls the gain of the gain adjusting section 123 according to the calculated frequency error, and the gain adjusting section 123 may perform gain adjustment according to the gain, set by the frequency error calculating section 132B.

### [Configuration Example of Computer]

The series of processes as described above may be executed by hardware or software. In a case where the series of processes is executed by software, a program that forms the software is installed in a computer. Here, the computer includes a computer that is assembled in dedicated hardware, a general-purpose personal computer capable of executing various functions, or the like by being installed with various programs.

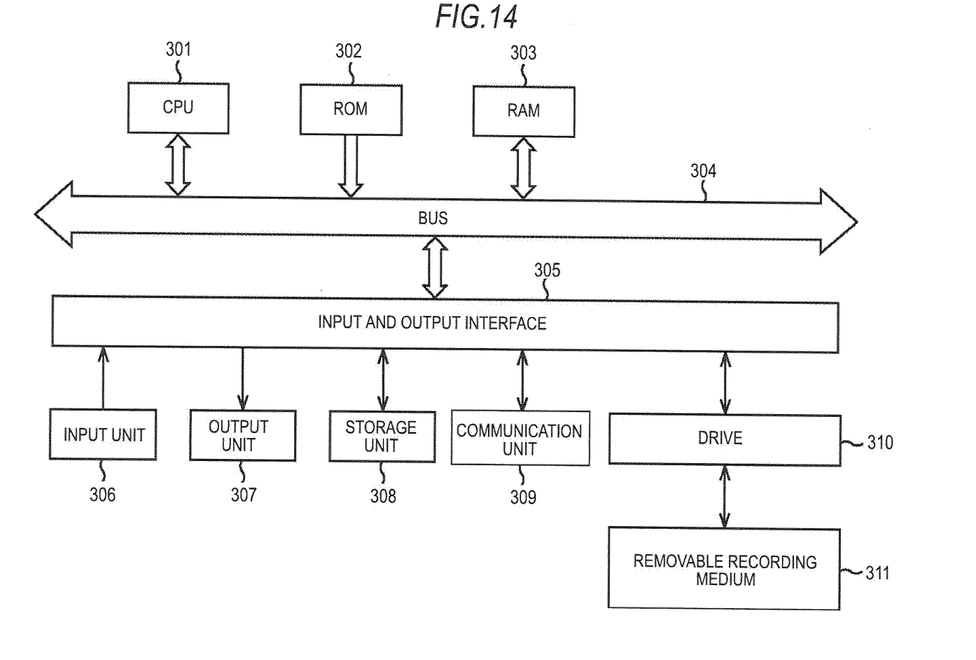

FIG. 14 is a block diagram illustrating a configuration example of hardware of a computer that executes the series of processes as described above by a program.

In the computer, a CPU (Central Processing Unit) 301, a ROM (Read Only Memory) 302, and a RAM (Random Access Memory) 303 are connected to each other through a bus 304.

Further, an input and output interface 305 is connected to the bus 304. An input unit 306, an output unit 307, a storage unit 308, a communication unit 309, and a drive 310 are connected to the input and output interface 305.

The input unit 306 includes a keyboard, a mouse, a microphone and the like. The output unit 307 includes a display, a speaker and the like. The storage unit 308 includes a hard disk, a non-volatile memory and or like. The communication unit 309 includes a network interface or the like. The drive 310 drives a removable recording medium 311 such as a magnetic disk, an optical disc, a magneto-optical disc or a semiconductor memory.

In the computer having such a configuration, the CPU 301 loads a program stored in the storage unit 308 on the RAM 303 through the input and output interface 305 and the bus 304 to execute the program, and thus, the series of processes as described above is performed.

In the computer, it is possible to install the program in the storage unit 308 through the input and output interface 305 by installing the removable recording medium 311 in the drive 310. Further, it is possible to receive the program by the communication unit 309 through a wired or wireless transmission medium such as a local area network, the internet or digital satellite broadcasting and to install the program in the storage unit 308. Further, the program may be installed in the ROM 302 or the storage unit 308 in advance.

In the present disclosure, the steps described in the flowchart may be performed in a time series manner according to the disclosed order, may be executed in parallel, or may not be necessarily executed in a time series manner but be executed at necessary timings such as a time when a call is made.

Further, embodiments of the present disclosure are not limited to the above-described embodiments, and various modifications may be made in a range without departing from the spirit of the present disclosure.

the present disclosure may be configured as follows.

(1) A synchronization processing apparatus including:

a jitter amount calculating section that calculates a jitter amount on the basis of a synchronization packet including time information; and

a frequency synchronization determining section that calculates an accumulation value of the jitter amounts, and determines whether frequency synchronization is present from the accumulation value.

(2) The synchronization processing apparatus according to (1)

wherein the frequency synchronization determining section includes

a jitter accumulating section that calculates the accumulation value of the jitter amounts and a jitter width; and

an error calculating section that calculates a frequency error from the jitter width, and the accumulation value of the jitter amounts at a first time and the accumulation value of the jitter amounts at a second time, and

wherein the error calculating section determines whether the frequency synchronization is present on the basis of the calculated frequency error.

(3) The synchronization processing apparatus according to (2)

wherein the frequency synchronization determining section further includes:

a comparing section that compares the accumulation value of the jitter amounts that is calculated in the jitter accumulating section with an upper limit threshold value and a lower limit threshold value, and outputs the comparison result,

wherein the upper limit threshold value is set as the accumulation value of the jitter amounts at the first time, and the lower limit threshold value is set as the accumulation value of the jitter amounts at the second time,

wherein the error calculating section calculates the frequency error from the jitter width and the time changed between the upper limit threshold value and the lower limit threshold value.

(4) The synchronization processing apparatus according to (3),

wherein the comparison result output from the comparing section is also used as a frequency error correction value for correcting the frequency error, and

wherein the synchronization processing apparatus further includes:

a control voltage generating section that generates a frequency control voltage based on the frequency error correction value output from the comparing section when the accumulation value of the jitter amounts that is calculated in the jitter accumulating section reaches the upper limit threshold value or the lower limit threshold value.

(5) The synchronization processing apparatus according to (3) or (4),

wherein the comparison result output from the comparing section is also used as a frequency error correction value for correcting the frequency error, and

wherein the synchronization processing apparatus further includes:

a gain adjusting section that adjusts a gain with respect to the frequency error correction value output from the comparing section.

(6) The synchronization processing apparatus according to (5),

wherein the gain adjusting section adjusts a gain based on the frequency error calculated in the error calculating section, with respect to the frequency error correction value output from the comparing section.

(7) The synchronization processing apparatus according to any one of (2) to (6), further including:

a control voltage generating section that generates a frequency control voltage for correcting the frequency error; and

an overlapping section that overlaps a periodic minute voltage to the frequency control voltage output from the control voltage generating section, in a case where the frequency error calculated in the error calculating section is in a predetermined range and it is determined that the frequency synchronization is present.

(8) A synchronization processing method including:

calculating a jitter amount on the basis of a synchronization packet including time information;

calculating an accumulation value of the calculated jitter amounts; and

determining whether frequency synchronization is present from the calculated accumulation value of the jitter amounts.

(9) A program that causes a computer to function as:

a jitter amount calculating section that calculates a jitter amount on the basis of a synchronization packet including time information; and

a frequency synchronization determining section that calculates an accumulation value of the jitter amounts calculated from the jitter amount calculating section, and determines whether frequency synchronization is present from the accumulation value of the calculated jitter amount.

The present disclosure contains subject matter related to that disclosed in Japanese Priority Patent Application JP 2012-016549 filed in the Japan Patent Office on Jan. 30, 2012, the entire contents of which are hereby incorporated by reference.

It should be understood by those skilled in the art that various modifications, combinations, sub-combinations and alterations may occur depending on design requirements and other factors insofar as they are within the scope of the appended claims or the equivalents thereof.

What is claimed is:

1. A synchronization processing apparatus comprising
a jitter amount calculating section that calculates a jitter amount on the basis of a synchronization packet including time information; and
a frequency synchronization determining section that calculates an accumulation value of the jitter amounts, and determines whether frequency synchronization is present from the accumulation value.

2. The synchronization processing apparatus according to claim 1,
wherein the frequency synchronization determining section includes:
a jitter accumulating section that calculates the accumulation value of the jitter amounts and a jitter width; and
an error calculating section that calculates a frequency error from the jitter width, and the accumulation value of the jitter amounts at a first time and the accumulation value of the jitter amounts at a second time, and
wherein the error calculating section determines whether the frequency synchronization is present on the basis of the calculated frequency error.

3. The synchronization processing apparatus according to claim 2,
wherein the frequency synchronization determining section further includes:
a comparing section that compares the accumulation value of the jitter amounts that is calculated in the jitter accumulating section with an upper limit threshold value and a lower limit threshold value, and outputs the comparison result,
wherein the upper limit threshold value is set as the accumulation value of the jitter amounts at the first time, and the lower limit threshold value is set as the accumulation value of the jitter amounts at the second time,
wherein the error calculating section calculates the frequency error from the jitter width and the time changed between the upper limit threshold value and the lower limit threshold value.

4. The synchronization processing apparatus according to claim 3,
wherein the comparison result output from the comparing section is also used as a frequency error correction value for correcting the frequency error, and
wherein the synchronization processing apparatus further comprises:
a control voltage generating section that generates a frequency control voltage based on the frequency error correction value output from the comparing section when the accumulation value of the jitter amounts that is calculated in the jitter accumulating section reaches the upper limit threshold value or the lower limit threshold value.

5. The synchronization processing apparatus according to claim 3,
wherein the comparison result output from the comparing section is also used as a frequency error correction value for correcting the frequency error, and
wherein the synchronization processing apparatus further comprises:
a gain adjusting section that adjusts a gain with respect to the frequency error correction value output from the comparing section.

6. The synchronization processing apparatus according to claim 5,
wherein the gain adjusting section adjusts a gain based on the frequency error calculated in the error calculating section, with respect to the frequency error correction value output from the comparing section.

7. The synchronization processing apparatus according to claim 2, further comprising;
a control voltage generating section that generates a frequency control voltage for correcting the frequency error; and
an overlapping section that overlaps a periodic minute voltage to the frequency control voltage output from the control voltage generating section, in a case where the frequency error calculated in the error calculating section is in a predetermined range and the frequency synchronization is determined to be present.

8. A synchronization processing method comprising;
calculating a jitter amount on the basis of a synchronization packet including time information;
calculating an accumulation value of the calculated jitter amounts; and
determining whether frequency synchronization is present from the calculated accumulation value of the jitter amounts.

9. A program that causes a computer to function as:
a jitter amount calculating section that calculates a jitter amount on the basis of a synchronization packet including time information; and
a frequency synchronization determining section that calculates an accumulation value of the jitter amounts calculated from the jitter amount calculating section, and determines whether frequency synchronization is present from the accumulation value of the calculated jitter amount.
